(19) United States
(12) Patent Application Publication
(10) Pub. No.: US 2007/0239498 A1
(43) Pub. Date: Oct. 11, 2007

(54) Framework for modeling cancellation for process-centric programs

(75) Inventors: Dharma Shukla, Sammamish, WA (US); Bob Schmidt, Woodinville, WA (US); Mayank Mehta, Redmond, WA (US); Akash J. Sagar, Redmond, WA (US); Karthik Raman, Bellevue, WA (US); Nathan Talbert, Seattle, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/393,357

(22) Filed: Mar. 30, 2006

(51) Int. Cl. G06F 17/50

(52) U.S. Cl. 705/7

(57) ABSTRACT

Declaratively canceling execution of an activity. A state automaton for an activity is defined, and the state automaton includes an executing state, a canceling state, and a closed state and classifies an execution lifetime of the activity. The activity includes work items and organizes the work items in an execution hierarchical structure. The work items are transitioned from the executing state to the closed state indicating a completion of executing the each work item of the activity. Upon having one of the work items being transitioned to the closed state, a cancellation request is transmitted to the work items currently in the executing state. The executing work items are identified as a function of the transmitted cancellation request and the execution hierarchical structure of the defined activity. The execution lifetime of the activity is canceled by transitioning the identified work items from the executing state to the canceling state.

### BACKGROUND

Process-oriented or process-centric programs have evolved to enable processing of complex instructions modeling real-world interactions between autonomous agents. Process-centric programs mirror real-world processes and mirror interactions between real-world entities. Process-centric programs mirror real-world processes and mirror interactions between real-world entities. Existing systems attempt to map business problems to high-level workflows by modeling the business problem. However, real world workflows vary in a variety of dimensions such as (a) execution and modeling complexity, (b) knowledge of the structure of the flow at design time, (c) statically defined or ad-hoc/dynamic, (d) ease of authoring and editing the flow at various points in its lifecycle, and (e) weak or strong association of business logic with the core workflow process. Existing models fail to accommodate all these factors.

Further, most existing workflow models are based on either language-based approaches (e.g., BPEL4WS, XLANG/S, and WSFL) or application based approaches. Language based approaches are high-level workflow languages with a closed set of pre-defined constructs which help model the workflow process to the user/programmer. The workflow languages carry all of the semantic information for the closed set of constructs to enable the user to build a workflow model. However, the languages are not extensible by the developers and represent a closed set of primitives that constitute the workflow model. The languages are tied to the language compiler shipped by the workflow system vendor. Only the workflow system product vendor may extend the model by extending the language with a new set of constructs in a future version of the product. This often requires upgrading the compiler associated with the language. In addition, the languages usually do not declaratively expose or define functions or operations that can be readily and efficiently used by other programs.

Application based approaches are applications which have the workflow capabilities within the application to solve a domain specific problem. These applications are not truly extensible nor do they have a programmable model.

In addition, with the existing approaches, the issues of complexity, foreknowledge, dynamic workflows, authoring ease, and strength of associations with business logic and core workflows are not adequately addressed. There are no extensible, customizable, and re-hostable workflow designer frameworks available to build visual workflow designers to model different classes of workflows. Existing systems lack a rapid application development (RAD) style workflow design experience which allows users to graphically design the workflow process and associate the business logic in a programming language of developer's choice.

Also, workflow processes deal with cross cutting orthogonal and tangled concerns that span multiple steps of a workflow process model. For example, while parts of the workflow process are designed to participate in long running transactions, other parts of the same process are designed for concurrent execution or for accessing a shared resource. Due to design shortcomings, existing systems fail to provide interleaving of execution threads which enable users to design synchronous or interleaved execution of activities. Still other portions of the same workflow process require tracking, while other portions handle business or application level exceptions. There is a need to apply certain behaviors to one or more portions of a workflow process.

Some workflow modeling approaches are impractical as they require a complete flow-based description of an entire business process including all exceptions and human interventions. Some of these approaches provide additional functionality as exceptions arise, while other approaches exclusively employ a constraint-based approach instead of a flow-based approach to modeling a business process. Existing systems implement either the flow-based or constraint-based approach. Such systems are too inflexible to model many common business situations. These systems also lack the capability to asynchronously handle exceptions or cancellations.

### SUMMARY

Embodiments of the invention provide a declarative framework to model cancellation in programs by defining a canceling state in a state automaton. In addition, with the canceling state and other aspects of the invention, developers or programs may declaratively define and provide users in processing cancellations of programs.

Furthermore, embodiments of the invention enable composite activities (e.g., a group of activities having a hierarchical structure) cancel the execution of one or more activities (e.g., children activities in an activity tree). Also, cancellation embodying aspects of the invention permit modeling early completion within a program and dynamic control flows.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is a block diagram illustrating an existing programming paradigm.

FIG. 2 is an exemplary block diagram illustrating a virtualization of a workflow design framework according to an embodiment of the invention.

FIG. 3 is an exemplary diagram illustrating an exemplary workflow according to an embodiment of the invention.

FIG. 4 is a diagram illustrating an exemplary computing environment of a system for processing workflow activities according to an embodiment of the invention.

FIG. 5 is a diagram illustrating a hierarchical structure of a workflow activity according to an embodiment of the invention.

FIG. 6 is a diagram illustrating an exemplary state automaton describing processing states of work items associated with an activity according to an embodiment of the invention.

FIGS. 7A to 7E are block diagrams illustrating a declarative cancellation of work items of an activity according to an embodiment of the invention.

FIG. 8 is a flow diagram illustrating a method for canceling work items of an activity of a workflow according to an embodiment of the invention.

FIG. 9 is a block diagram illustrating an exemplary computer-readable medium on which aspects of the invention may be stored.

Corresponding reference characters indicate corresponding parts throughout the drawings.

### DETAILED DESCRIPTION

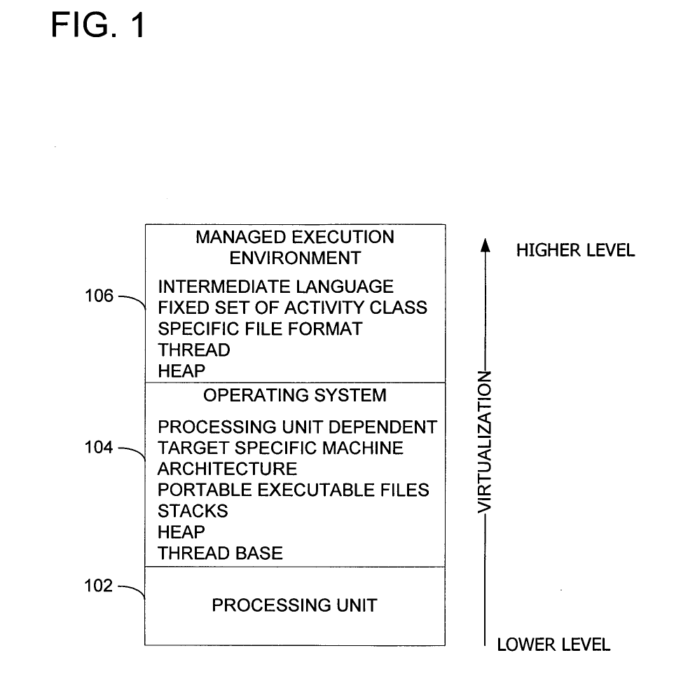

Referring first to FIG. 1, a block diagram illustrates an existing programming paradigm for designing programs for process-centric activities, such as a workflow. For example, the diagram shows a three-level virtualization model of existing program paradigm with a level of a managed execution environment being the highest level and a processing unit being the lowest level. In this programming design system, even at the managed execution environment level, programs, especially process-centric programs handling workflow processes, lack the ability and efficiency to accommodate complex interactions between processes in a workflow.

It is known by those skilled in the art that certain constraints are associated with designing software or application programs. In this example, in writing an operating system software program 104, the programming codes or routines are dependent on the type or configuration of processing units 102, being specific to the type of computing architecture (e.g., IBM® compatible, APPLE® computers, or other systems), or other constraints. In addition, programming languages typically need to accurately identify and utilize data structures such as stacks, heap, thread base, or other hardware-specific structures for the operating system 104 to function properly.

In dealing with complex workflow processes, existing applications use a concept of a managed execution environment 106 (e.g., a runtime environment where programs may share functions or common object-oriented classes) in which programs written one programming language may call functions in other programs written in a different programming language. In such execution environment, these programs in different programming languages are compiled to an intermediate language such that the managed execution environment 106 may expose parameters, arguments, or schemas or functions to the different programs so that the programs may interact with one another.

While this execution environment 106 creates a common communication environment between programs, the execution environment 106 includes various strict requirements that may not be suitable for handling the complexity and capability of process-centric programs. For example, the execution environment 106 requires programs be confirmed to a specific file format. The execution environment 106 also requires that functions or operations in the programs use a fixed set of functions or a class of functions defined by the execution environment 106.

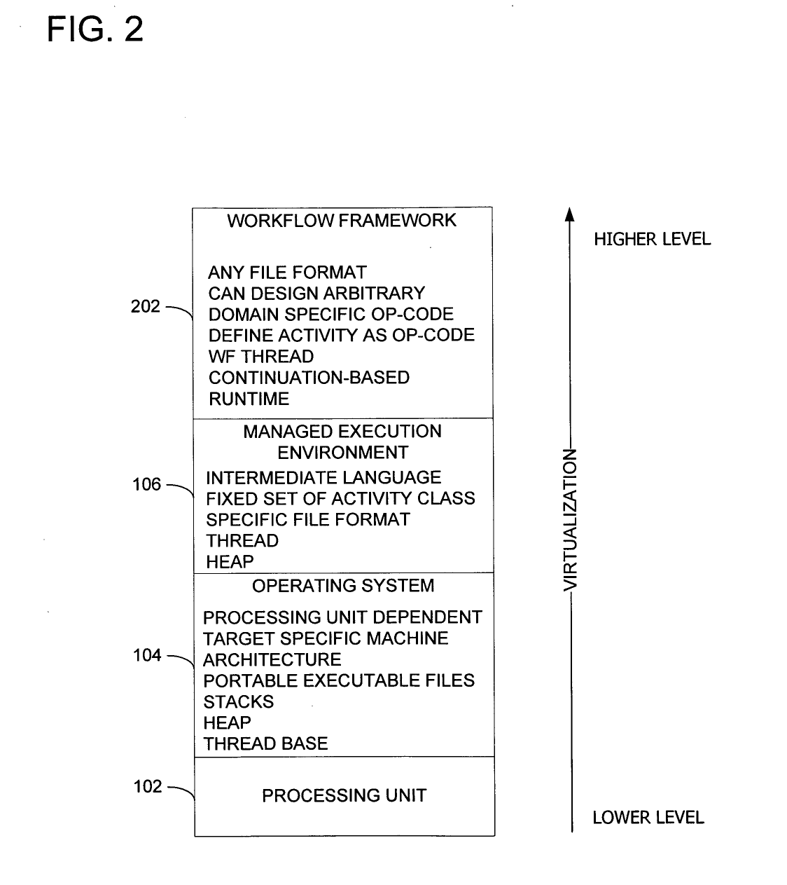

Embodiments of the invention build on an extensible foundation or framework 202 in FIG. 2 to overcome the shortcomings of existing programming model. By allowing programs written in any programming language and composed in any file format, aspects of the invention enable program developers to design programs with specific functions without compromising its functionalities and specifics. By defining activities, such as workflow tasks or processes, as the base class to be executed in the workflow framework, developers can easily and efficiently build domain specific (e.g., specific execution environments such as programs in the healthcare industrial, financial industry, or the like) operation codes (hereinafter “op-code”) without adhering to the rigid, hard-coded, inflexible, and the fixed set of functions or activities classes in the existing execution environment. In addition, the workflow foundation embodying aspects of the invention is a continuation based runtime layered on top of any existing framework (e.g., either a managed execution environment, an operating system environment, or a hardware processing unit level).

Aspects of the invention free the constraint of defining activities in a particular file format by enabling workflow designs in any fashion or representation (e.g., a flow chart, a diagram, a numbered description, or the like) as long as activities in the workflow can be constructed from the representation of the workflow designs.

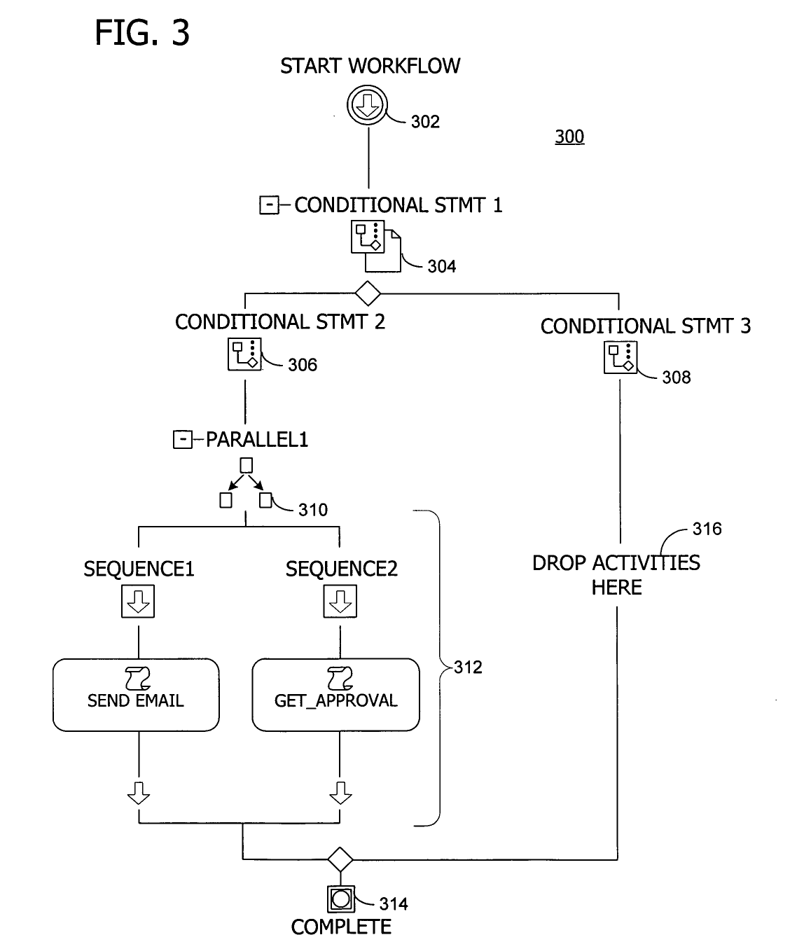

FIG. 3 illustrates a simplistic view of a workflow 300 according to an embodiment of the invention. For example, the workflow 300 may be a workflow for processing a purchase order, and this purchase order workflow 300 may include processes or activities such as receive a purchase order, send confirmation to a customer, approve the purchase order by a manager, or the like. Further, these activities may be sequenced such that some may be performed at the same time as others, while some others may be performed only up on the completion of other activities.

The workflow 300 may start from a starting point 302. For example, the starting point 302 for a purchase-order workflow may be receiving an order from a customer. The workflow 300 may also include a conditional statement 304 (such as an “IF statement” or a “WHILE statement”), and it can be subdivided into additional conditional statements 306 and 308. The workflow 300 may also include a parallel structure 310, which further includes one or more sequences or activities 312. For example, the parallel structure 310 includes activities, such as checking the inventory and updating the available shippers, be processed in parallel. In the example shown, activities such as “Send E-mail” and “Get Approval” may be processed in parallel. At “drop activities here” 316, a user may further add or supplement more activities into the workflow 300. To complete the workflow 300, the processes or activities will conclude in a complete step or point 314.

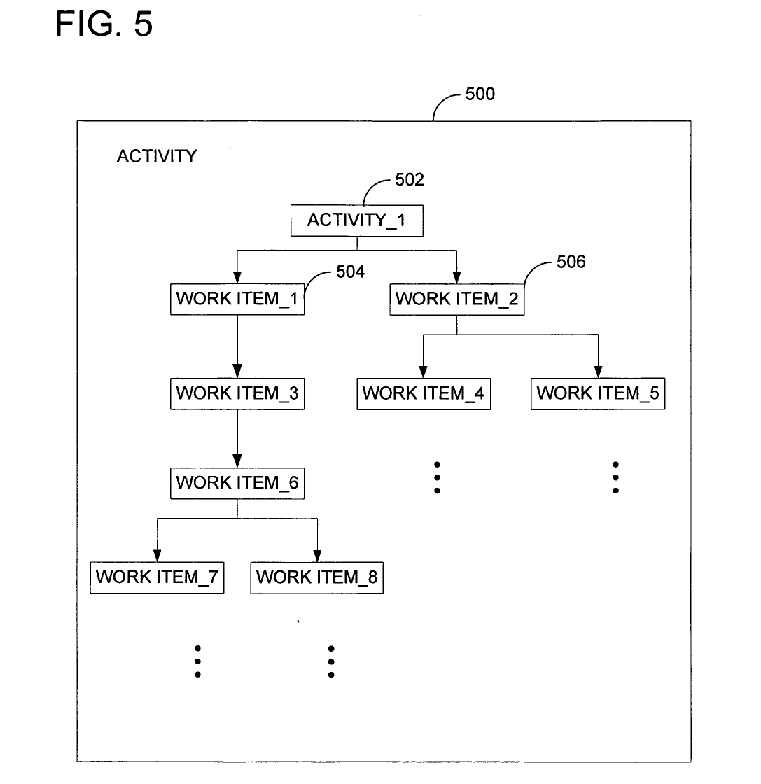

In one embodiment, the activities may be arranged hierarchically in a tree structure (see FIG. 5) 500 or other execution sequences. For example, an activity may be a composite activity in which the activity includes more than one work item associated therewith. An activity method may be in a root node 502 with two children or leaf nodes 504 and 506. The activity methods in the children nodes 504 and 506 (e.g., work item_1 and work item_2, respectively) may be executed according to the hierarchical structure. In addition, the children nodes 504 and 506 may also include other children nodes having respective work items to be executed.

In another embodiment, activities include one or more of the following types: a simple activity, container activity and root activity. In this embodiment, there is one root activity in the model, and none or any quantity of simple activities or container activities inside the root activity. A container activity may include simple or container activities. The entire workflow process may be used as an activity to build higher-order workflow processes. Further, an activity may be interruptible or non-interruptible. A non-interruptible composite activity does not include interruptible activities. A non-interruptible activity lacks services that would cause the activity to block.

Moreover, in executing activities and the work items included in the activities, the workflow framework defines an execution context or environment that is a scope or boundary for each of the work items. This scope or boundary includes and exposes information (e.g., in the form of data, metadata, or the like) such as the shared data or resources to be accessed by the work items, associated properties, handlers, constraints and interactions between autonomous agents. These scopes may be structured hierarchically. Also, each activity may be configured by a user code in any programming language that supports the underlying managed framework. For example, the user code may represent business or application logic or rules written in a specific domain or execution environment. Each activity may support pre-interception hooks and post-interception hooks into execution in the user code. Each activity has associated runtime execution semantics and behavior (e.g., state management, transactions, event handling and exception handling). Activities may share state or resources with other activities. In addition, activities may be primitive activities or grouped into a composite activity. A primitive or basic activity has no substructure (e.g., child activities), and thus is a leaf node in a tree structure. A composite activity contains substructure (e.g., it is the parent of one or more child activities).

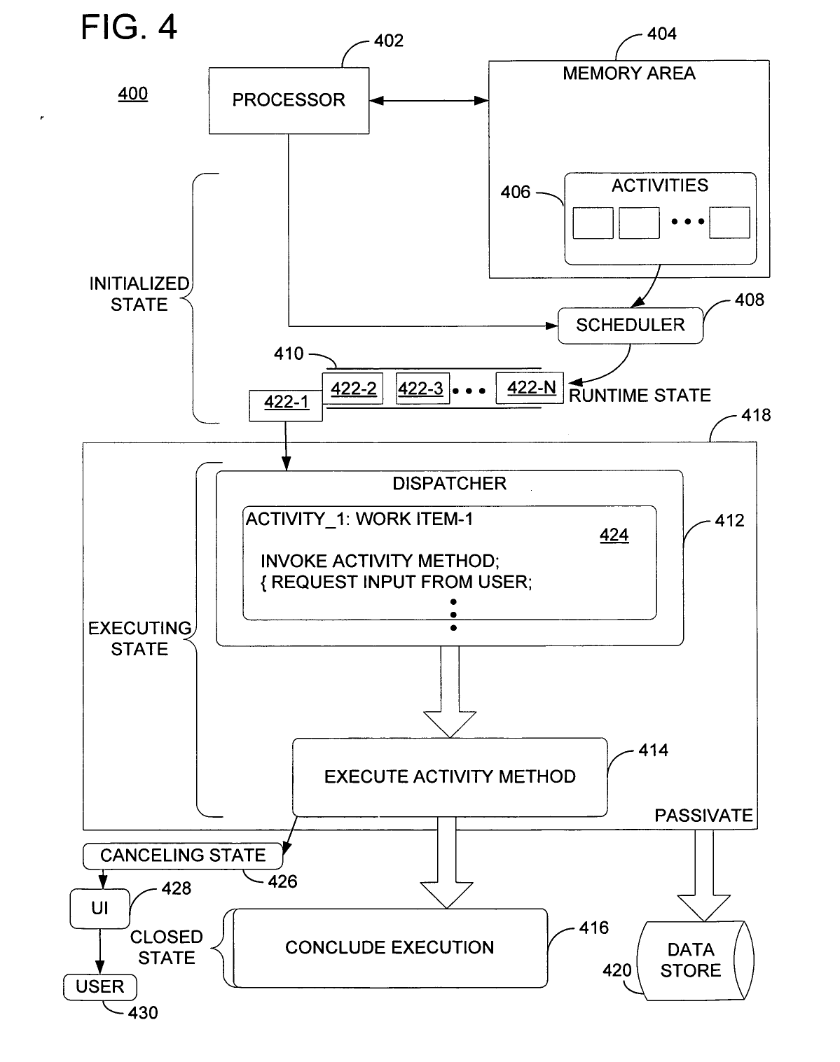

FIG. 4 is a diagram illustrating a system 400 for processing workflow activities according to an embodiment of the invention. The system 400 includes a processor 402, which may be a processing unit or a collection of processing units. The system 400 also includes a memory area 404 for storing data accessible by the processor 402. In one embodiment, the system 400 may be a computer having one or more processors or processing units (e.g., processor 402) and a system memory (e.g., memory area 404) having other components to couple various system components including the system memory to the processor 402.

In one example, the memory area 404 may include computer readable media, either volatile, nonvolatile, removable, or non-removable media, implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by the system 400. The memory 404 may also include communication media embodying computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

In one example, the memory area 404 stores a plurality of activities 406 for processing in a workflow (e.g., the workflow 300). Each of the plurality of activities 406 includes one or more work items, and the work items may be organized in a hierarchical structure such as a tree structure (see FIG. 5). In processing the plurality of activities 406, the processor 402 accesses or executes a scheduler 408, which is configured to set up an organized set of activities.

For example, the processor 408 accesses the work items in the plurality of activities 406 via a component or a set of computer-executable instructions such as the scheduler 408 to enqueue or store the work items 422 to a queue 410. A dispatcher 412, accessible by the processor 402, dispatches the work items 422 for execution. For example, a work item 422-1 may include an activity method 424, routine, or a collection of codes for performing a function of “requesting input from a user”. One or more other activity methods, routines, or codes may be included in each of the work items 422 without departing from the scope of the invention.

Once the work items 422 are dispatched by the dispatcher 412, the processor 402 executes each of the methods 424 in the work items 422 at 414. In the example of work item 422-1, the processor 402 may provide a user via a user interface (UI) to input the requested information or data. In another embodiment, the processor 402 may connect to or access an external data source for requesting input from the user. Upon completion of the activity method 424, the processor 402 concludes execution of the work items 422 at 416. In one embodiment, the processor 402 passivates the executing state of work items at 418 to a data store 420.

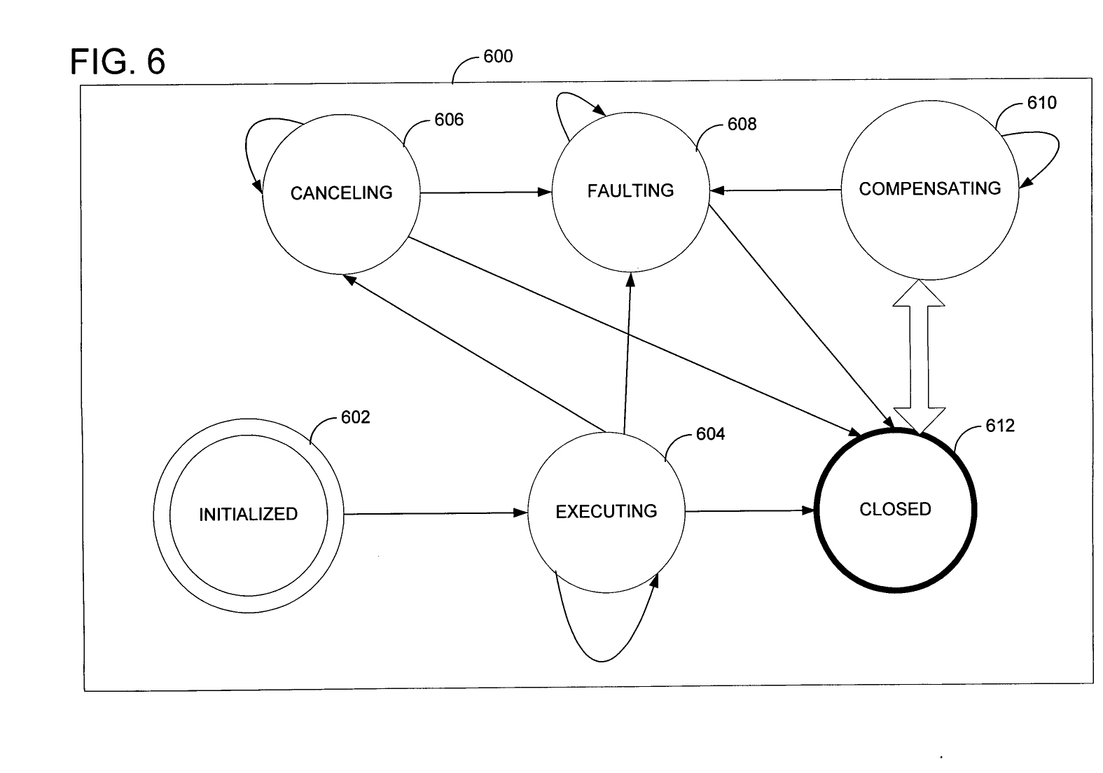

In another embodiment, the processor 402 executes the work items 422 according to a state automaton, such as the automaton shown in FIG. 6, which is a diagram illustrating an exemplary state automaton 600 describing processing states of work items associated with an activity according to an embodiment of the invention. In one embodiment, the state automaton 600 defines an execution lifetime of an activity. In one example, the state automaton 600 may include an initialized state, an executing state, and a closed state (as shown in FIG. 4). In another embodiment, the state automaton 600 includes an initialized state 602, an executing state 604, a canceling state 606, a faulting state 608, a compensating state 610, and a closed state 612.

For example, the state automaton 600 describes a process flow of execution of work items (e.g., work items 422) in a workflow activity. The work item 422-1, as illustrated in FIG. 4, is first initialized when it is enqueued in the queue 410. The work item 422-1 is next dequeued or removed from the queue 410 to the dispatcher 412 before being executed in the executing state (e.g., executing state 604 in FIG. 6). Depending on the parameters or conditions during the execution of the work item 422-1, the work item 422-1 may proceed to the canceling state 606 or the faulting state 608. In one embodiment, the work item 422-1 may proceed from the canceling state 606 to the faulting state 608. In an alternative embodiment, the compensating state 610 describes a set of operations or functions to be performed when faulting or exception has occurred.

For example, suppose an exception occurs during the execution of a work item (e.g., work item 422-1), such as a parameter for a function is missing. The system 400 transitions the work item 422-1 to the faulting state 608. In doing so, the system 400 also performs garbage collection (e.g., removing previously executed portion of the operations from cache or memory, reset parameter values, or the like) operations in the compensating state 610 before transitioning the work item 422-1 to the closed state 612. The closed state 612 indicates that the execution of the activity (e.g., activity 500 in FIG. 5) has completed.

In one embodiment, the state automaton 600 establishes relationship between work items in a composite activity. For example, one of the relationship rules may include that, before transitioning to the closed state 612 methods or work items in the root node of the activity tree, all of the work items in the children nodes should be in the initialized state 602 or the closed state 612. Another rule may require that, in order to transition the work items in the children node of the activity tree to the executing state 604, the work item in the root node must already be in the executing state 604.

In another embodiment, one or more additional states may be defined in the state automaton 600 without departing from the scope of embodiments of the invention.

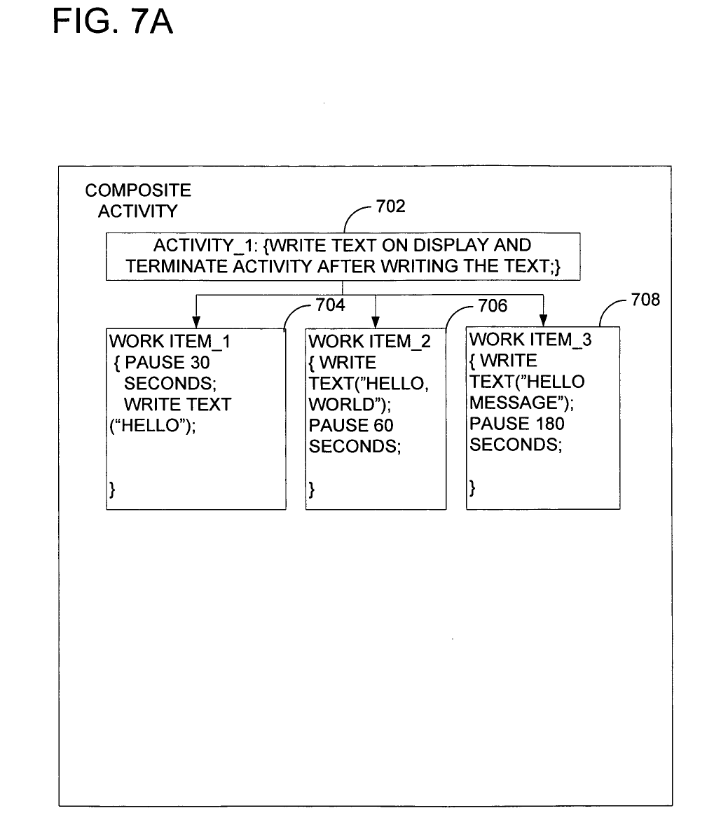

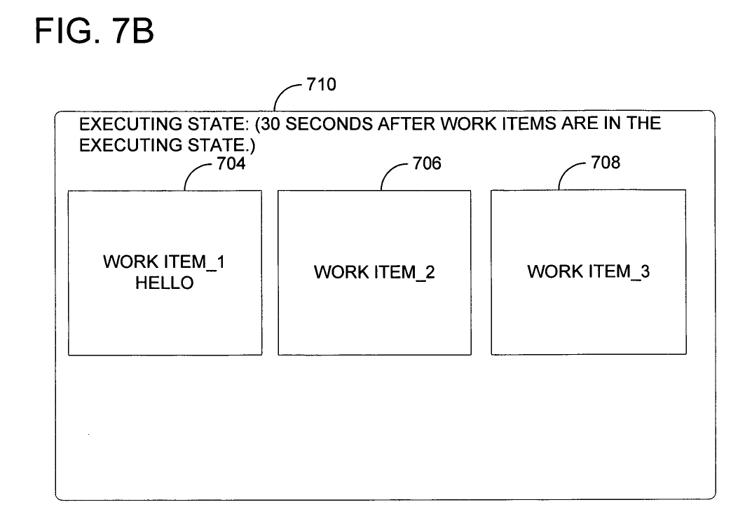

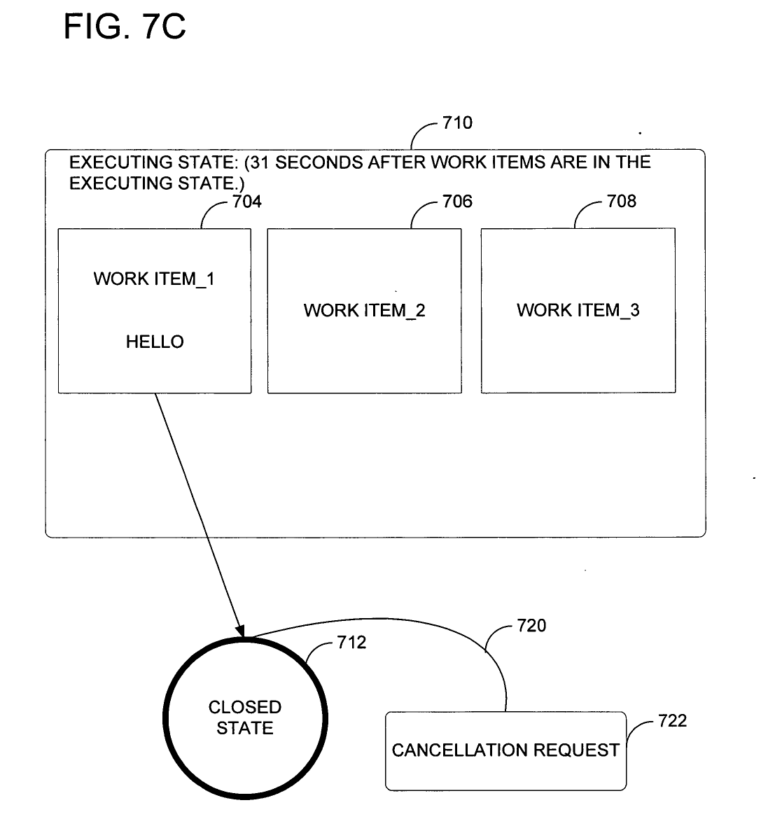

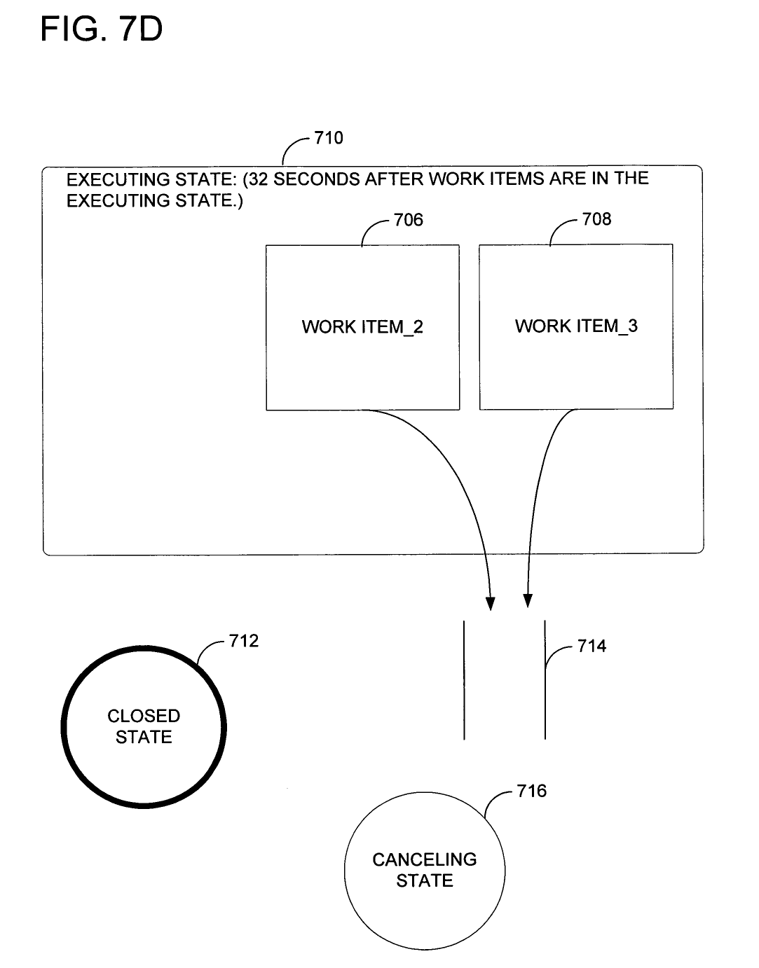

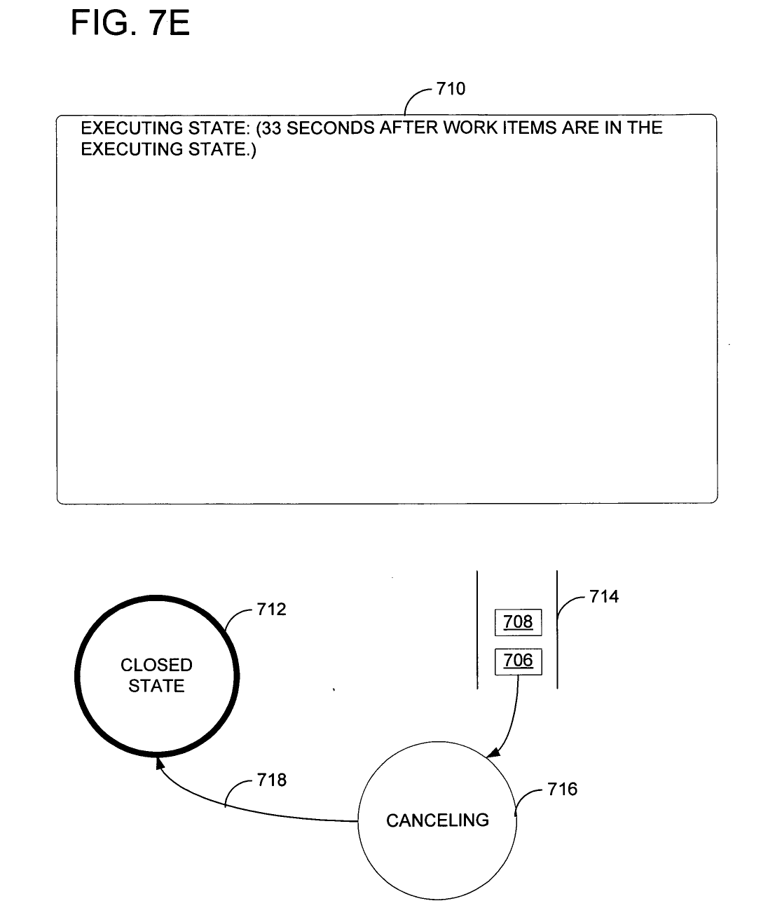

Referring next to FIGS. 7A to 7E, block diagrams illustrate a declarative cancellation of work items of an activity according to an embodiment of the invention. For simplistic purposes only and without limitations, FIG. 7A shows a composite activity 702 which includes three children work items organized in a tree structure: work item_1 704, work item_2 706, and work item_3 708. As illustrated, the root activity 702 includes a method to “write text on display and terminate the activity after writing the text.” Functions for the work items above also provide the following:

```
work item_1 704:
{ PAUSE 30 SECONDS;
  WRITE TEXT(“HELLO”);
}
work item_2 706:
{ WRITE TEXT(“HELLO WORLD”);
  PAUSE 60 SECONDS;
}
work item_3 708:
{ WRITE TEXT(“HELLO MESSAGE”);
  PAUSE 180 SECONDS;
}
```

In FIG. 7B, a snapshot (i.e., 30 seconds after work items are in the executing state 710) of the executing state 710 illustrates the work items that are currently in the executing state. It is to be understood that the activity 702 is also already in the executing state 710 at this point. At this stage, according to the function included in the work item_1 704, the text “Hello” is displayed on a display, such as a user interface (UI) 428 in FIG. 4.

In FIG. 7C, at a time of 31 seconds after work items are in the executing state, the functions in the work item_1 704 has completed executing (i.e., writing “Hello” on the display). The work item_1 704 is transitioned to a closed state 712. Upon transitioning to the closed state 712, a cancellation request 722 is transmitted at 720 to one or more of the work items currently in the executing state, such as the work item_2 706 and the work item_3 708.

According to embodiments of the invention, all remaining work items in the activity tree are transitioned to the canceling state because the activity 702 has completed execution of its method, which is “write text on display and terminate the activity after writing the text.” As such, the activity 702 should be transitioned to the closed state 712. Consequently, the operations, functions or methods that are currently in the executing state 710 would be discarded or the execution of them would not complete.

As such, in FIG. 7D, at a time of 32 seconds after work items are in the executing state 710, the work item_2 706 and the work item_3 708 are transitioned to a canceling state 716. In one embodiment, the work item_2 706 and the work item_3 708 are enqueued to a scheduler queue 714 before transitioning to the canceling state 716 (e.g., canceling state 426 in FIG. 4). In FIG. 7E, the work item_2 706 and the work item_3 708 are dequeued from the scheduler queue 714 and are being transitioned to the canceling state 716. In this illustration, upon all of the work items being transitioned to the closed state (as indicated by an arrow 718), the activity 702 transitions to the closed state 712, indicating that the activity 702 has completed its execution.

Unlike existing systems where an exception would be triggered, aspects of the invention declaratively trigger cancellation by providing the canceling state 716. With the canceling state 716, developers or programmers may design process-centric programs to efficiently handle cancellation of parts of the program.

Upon transitioning work items to the canceling state 716, alternative embodiments of the invention provide a set of post-cancellation operations to a user 430 in response to canceling of the execution lifetime of the activity. For example, the system 400 in FIG. 4 may provide a number of operations in a dialog window via the UI 428 to the user 430. The operations may include, but not limited to, a decision box to also cancel remaining work items in the executing state 710, perform other operations, or the like. Alternative embodiments of the invention may perform a set of operations to remove data (e.g., temporary storages, buffers, memory accesses, or the like) associated with execution of the work items as a function of the cancellation of execution lifetime of the activity.

In one embodiment, FIG. 6 describes an automaton including six states (Initialized, Executing, Closed, Canceling, Faulting and Compensating states) in which an activity (e.g., a set of operations that may define a set of op-codes specific to its domain) may be in during its execution lifetime. In incorporating cancellation features as described above, the work items are dequeued from the scheduler queue and before the execution handler is actually dispatched. The automaton 600 applies alike to both primitive and composite activities.

It is also to be noted that the composition relationship between the parent and the child is enforced according to embodiments of the invention such that a composite activity enable modeling of the control flow patterns.

For example, composition of children within a parent activity in an activity tree requires the following:

(1). In order for the parent activity to transition to the closed state, the required pre-condition is that either the children should be in initialized state or in the closed state. In this example, children activity or children work items may not be in the executing state, canceling state, faulting state or compensating state when the parent transitions to the closed state.

(2). In order for a child to transition to the executing state, the required pre-condition is that the parent must already be in an executing state, canceling state, faulting state, compensating state or other “<>ing” states.

In an exemplary embodiment, the workflow foundation or framework runtime enforce the above rules or requirements strictly. Additionally, the workflow framework provides a well defined protocol for modeling cancellation for the activity writers based on the descriptions above. The cancellation propagates downwards in the activity composition hierarchy—starting from a parent composite activity scheduling the cancellation of its child, which in turn cancelling its child and so on. This example is similar to how the execution signal propagates downwards in the composition structure as well.

Unlike existing technologies where cancellation has been treated as an exception, embodiments of the invention model cancellation as a special behavior of the normal execution semantics of composite activities so that dynamic control flows of activity execution is achieved.

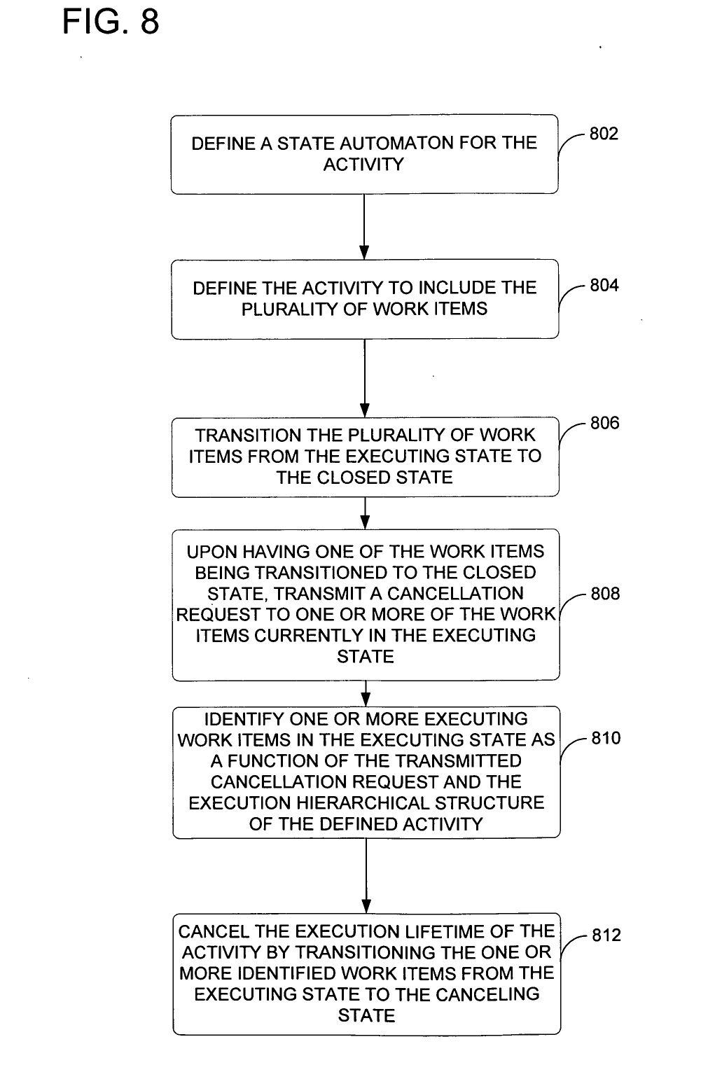

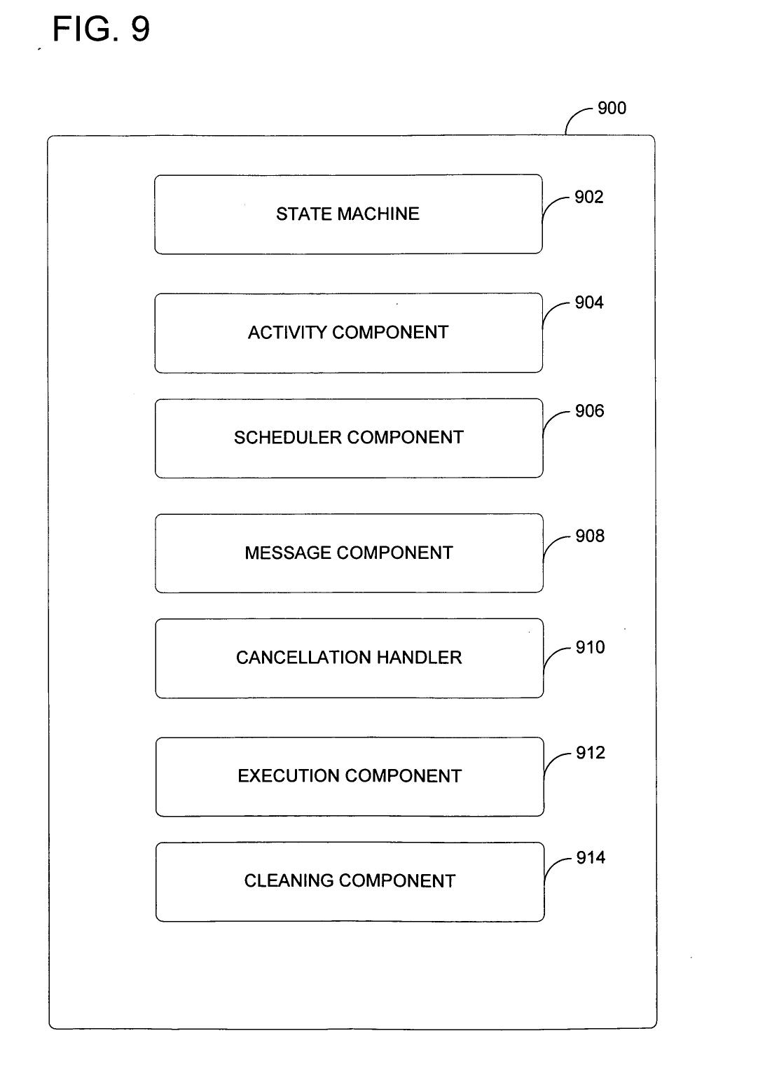

FIG. 8 is a flow diagram illustrating a method for canceling work items of an activity of a workflow according to an embodiment of the invention. In one example, the method or process described in FIG. 8 may be performed by computer-executable components stored on a computer-readable medium, such as a computer-readable medium 900 illustrated in FIG. 9. For example, initially, a state machine 902 defines a state automaton for the activity at 802. The state automaton (e.g., state automaton 600) includes an executing state, a canceling state, and a closed state. An activity component 904 defines the activity to include the plurality of work items at 804. The defined activity organizes the plurality of work items in an execution sequence or an execution hierarchical structure (e.g., a tree structure). Each of the work items includes a method for executing a portion of the activity.

At 806, a scheduler component 906 transitions the work items from the executing state to the closed state, said closed state indicating a completion of executing the activity. At 808, in response to one of the work items being transitioned to the closed state, a message component 908 transmits a cancellation request to one or more of the work items currently in the executing state. A cancellation handler 910 identifies one or more work items in the executing state as a function of the transmitted cancellation request and the execution sequence of the defined activity at 810. In one embodiment, the cancellation handler 910 identifies the work items by enqueuing the work items to a scheduler queue before transitioning the work items to the canceling state.

At 812, an execution component 912 cancels the execution lifetime of the activity by transitioning the one or more identified work items from the executing state to the canceling state. In another embodiment, the computer-readable medium 900 also includes the (UI) (e.g., UI 428) for providing a set of post-cancellation operations to the user 430 in FIG. 4 in response to canceling of the execution lifetime of the activity. In yet another embodiment, a cleaning component 914 removes data associated with execution of the work items as a function of the cancellation of execution lifetime of the activity by the execution component.

Although described in connection with an exemplary computing system environment, such as the system 400 in FIG. 4, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

In operation, the system 400 executes computer-executable instructions such as those illustrated in the figures, such as FIG. 8, to implement aspects of the invention. For example, suppose a user wishes to sell a vehicle as a “car sale activity.” By formulating the activity in a file and in any format, embodiments of the invention are able to process such workflow activity. This “car sale activity” may include one or more work items such as: advertise the sale on-line; advertise the sale via radio stations; advertise the sale via the classified section of a newspaper; and advertise the sale by posting a “for sales” sign on the vehicle's window. The activity also provides that, once the user accepts an offer from any source, the user is to cancel the advertising effort to avoid receiving and/or accepting multiple offers.

For example, suppose the user receives and accepts an offer from someone seeing the advertisement posted online. The “advertise the sale on-line” work item is transitioned to the closed state, triggering a notification to all other work items currently in the executing state. Embodiments of the invention may additional request the user to indicate if any of the post-cancellation operations may be performed, such as “notify newspaper,” “notify undecided and potential buyers,” “withdraw online advertisement,” or the like. As such, the activity is eventually transitioned to the closed state, terminating the “car sale activity” in a declarative fashion.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A method for declaratively canceling an activity in a process-centric program, said method comprising:
defining a state automaton for the activity, said state automaton including an executing state, a canceling state, and a closed state, said state automaton classifying an execution lifetime of the activity;
defining the activity to include the plurality of work items, said defined activity organizing the plurality of work items in an execution hierarchical structure, each of the work items including a method for executing a portion of the activity;
transitioning the plurality of work items from the executing state to the closed state, said closed state indicating a completion of executing the activity;
upon having one of the work items being transitioned to the closed state, transmitting a cancellation request to one or more of the work items currently in the executing state;
identifying one or more work items in the executing state as a function of the transmitted cancellation request and the execution hierarchical structure of the defined activity; and
canceling the execution lifetime of the activity by transitioning the one or more identified work items from the executing state to the canceling state.

2. The method of claim 1, further comprising transitioning the one or more identified work items from the canceling state to the closed state in response to canceling of the execution lifetime of the activity.

3. The method of claim 1, further comprising providing a set of post-cancellation operations to a user in response to canceling of the execution lifetime of the activity.

4. The method of claim 1, wherein identifying the one or more work items comprises enqueuing the work items to a scheduler queue.

5. The method of claim 4, wherein canceling comprises dequeuing the work items from the scheduler queue to the canceling state.

6. The method of claim 1, wherein the execution hierarchical structure comprises a tree structure, and wherein identifying the one or more work items comprises identifying the one or more work items in the executing state by traversing the tree structure from a lower level in the tree structure to a higher level in the tree structure.

7. The method of claim 1, wherein one or more computer-readable media have computer-executable instructions for performing the method of claim 1.

8. A system for declaratively canceling an activity in a process-centric program, said system comprising:
a memory area for storing data associated with the work items of the activity, said activity organizing the work items in an execution sequence;
a processor configured for executing computer-executable instructions for:
defining a state automaton for the activity, said state automaton including an executing state, a canceling state, and a closed state, said state automaton classifying an execution lifetime of the activity;
defining the activity to include the work items;
transitioning the work items from the executing state to the closed state, said closed state indicating a completion of executing the activity;
upon having one of the work items being transitioned to the closed state, transmitting a cancellation request to one or more of the work items currently in the executing state;
identifying one or more work items in the executing state as a function of the transmitted cancellation request and the execution sequence of the defined activity; and
canceling the execution lifetime of the activity by transitioning the one or more identified work items from the executing state to the canceling state.

9. The system of claim 8, further comprising means for transitioning the one or more identified work items from the canceling state to the closed state in response to the canceled execution lifetime of the activity.

10. The system of claim 8, further comprising means for providing a set of post-cancellation operations to a user in response to canceling of the execution lifetime of the activity.

11. The system of claim 8, wherein the processor is configured to identify the one or more work items comprises enqueuing the work items to a scheduler queue in the memory area.

12. The system of claim 11, wherein the processor is configured to dequeue the work items from the scheduler queue to the canceling state in response to the canceled execution lifetime of the activity.

13. The system of claim 8, wherein the execution sequence comprises a tree structure, and wherein the processor is configured to identify the one or more work items by traversing the tree structure from a lower level in the tree structure to a higher level in the tree structure.

14. The system of claim 8, further comprising means for removing data associated with the work items from the memory area as a function of the canceled execution lifetime of the activity.

15. One or more computer-readable media having computer-executable components for declaratively canceling an activity in a process-centric program, said computer-executable components comprising:
a state machine for defining a state automaton for the activity, said state automaton including an executing state, a canceling state, and a closed state, said state automaton classifying an execution lifetime of the activity;
an activity component for defining the activity to include the plurality of work items, said defined activity organizing the plurality of work items in an execution sequence, each of the work items including a method for executing a portion of the activity;
a scheduler component for transitioning the work items from the executing state to the closed state, said closed state indicating a completion of executing the activity;
a message component, responsive to one of the work items being transitioned to the closed state, for transmitting a cancellation request to one or more of the work items currently in the executing state;
a cancellation handler for identifying one or more work items in the executing state as a function of the transmitted cancellation request and the execution sequence of the defined activity by enqueuing the identified work items to a queue; and
an execution component for canceling the execution lifetime of the activity by transitioning the one or more identified work items from the executing state to the canceling state.

16. The computer-readable media of claim 15, wherein the scheduler component is configured to transition the one or more identified work items from the canceling state to the closed state.

17. The computer-readable media of claim 15, further comprising a user interface (UI) for providing a set of post-cancellation operations to a user in response to canceling of the execution lifetime of the activity.

18. The computer-readable media of claim 15, wherein the cancellation handler is configured to dequeue the work items from the queue to the canceling state.

19. The computer-readable media of claim 15, wherein the execution sequence comprises a tree structure, and wherein the cancellation handler is configured to identify the one or more work items by traversing the tree structure from a lower level in the tree structure to a higher level in the tree structure.

20. The computer-readable media of claim 15, further comprising a cleaning component for removing data associated with execution of the work items as a function of the cancellation of execution lifetime of the activity by the execution component.
